(19) United States
(12) Patent Application Publication
(10) Pub. No.: US 2013/0031249 A1
(43) Pub. Date: Jan. 31, 2013

(54) SYSTEM AND METHOD FOR SERVICING FIELD DEVICES IN AN AUTOMATION PLANT

(71) Applicants: Michael Gunzert, Herxheim (DE); Immanuel Vetter, Sinzheim (DE)

(72) Inventors: Michael Gunzert, Herxheim (DE); Immanuel Vetter, Sinzheim (DE)

(73) Assignee: CodeWrights GmbH, Karlsruhe (DE)

(21) Appl. No.: 13/556,499

(22) Filed: Jul. 24, 2012

(30) Foreign Application Priority Data
Jul. 27, 2011 (DE) 10 2011 079 890.0

(51) Int. Cl. G06F 15/173

(52) U.S. Cl. 709/224

(57) ABSTRACT

A system for servicing field devices in an automation plant, comprising: a computing unit, which accesses the field devices via a communications network; a communications hardware; a server; an interpreter for electronic device descriptions; and a software component. The server, the interpreter for the electronic device descriptions and the software component are associated with the communications hardware. The software component, upon the occurrence of an event, identifies, by means of scanning, or polling, the field devices arranged in the communications network and utilizes the identification of the field devices, in order to activate corresponding electronic device descriptions in the interpreter and to provide correspondingly prepared information via the server to the computing unit for the purpose of servicing the field devices.

The invention relates to a system for servicing field devices in an automation plant. Furthermore, the invention relates to a method for using the system of the invention.

In automation technology, especially in process automation technology, field devices are often applied, which serve for registering and/or influencing process variables. Serving for registering process variables are sensors, which are integrated, for example, in fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity, respectively. Serving for influencing process variables are actuators, such as, for example, valves or pumps, via which the flow of a liquid in a pipeline section, or the fill, level in a container, can be changed. Referred to as field devices are, in principle, all devices, which are applied near to the process and which deliver, or process, process relevant information. Thus, in connection with the invention, falling under field devices are also remote I/Os, radio adapters, and, generally, all devices, located at the field plane. A large number of such field devices are available from the firm, Endress+Hauser.

In modern industrial plants, communication between at least one superordinated control unit and the field devices occurs, as a rule, via a bus system, such as, for example, the Profibus® PA, Foundation Fieldbus® or HART® bus system. The bus systems can be embodied both wired as well as also wirelessly. The superordinated control unit serves for process control, process visualizing, and process monitoring as well as for start-up and servicing of the field devices and is also referred to as a configuration/management system. Programs, which run self-sufficiently on superordinated units, include, for example, operating, or servicing, tools, such as the FieldCare tool of the Endress+Hauser group of firms, the PACTware tool, the AMS tool of Fisher-Rosemount or the PDM tool of Siemens. Operating, or servicing, tools, which are integrated in control system applications, include the PCS7 tool of Siemens, the Symphony tool of ABB and the Delta V tool of Emerson. Under the terminology ‘servicing field devices’ in connection with the invention is meant especially the configuring and parametering of field devices, and, also, diagnosis for the purpose of early detecting of defects in one of the field devices or in the process. The term “servicing” includes, also, the display of information.

Before the introduction of digital communication in automation technology, a screw driver was sufficient for parametering and configuration of a field device. Today, usually an extensive amount of software must be installed in a computing unit, in order to be able to parameter, or configure, a field device such that it works correctly in the communications network, in which it is integrated.

The integration of field devices in configuration/management systems occurs usually via electronic device descriptions, which enable that the configuration/management systems can detect and interpret the data delivered from the field devices. As a rule, the respective device manufacturer provides device descriptions for each field device type, or for each field device type in different applications. In order that the field devices can be integrated in different fieldbus systems, different device descriptions must be created for the different fieldbus systems. Thus, there are—in order to name only some examples—HART-, Fieldbus Foundation- and Profibus-device descriptions. The number of device descriptions is very large, corresponding to the large number of different field devices, or field device types, in the different applications and bus systems. Usually, the device descriptions must be stored in the respective configuration/management system.

For the purpose of creating a unitary description language for field devices, Fieldbus Foundation (FF), HART Communication Foundation (HCF) and Profibus Nutzerorganisation (PROFIBUS User Organization, or PNO) have created a unified electronic device description language (Electronic Device Description Language EDDL). The EDDL, respectively the corresponding Electronic Device Description EDD, is defined in the standard, IEC 61804-2.

If a manufacturer offers a large number of field device types, or field device types for different applications, in its product portfolio, then the device descriptions EDD form a more or less large device description—or device driver—library. The library is usually delivered as a Windows installation package. Procuring the device descriptions and their installation is very time consuming and, depending on safety restrictions, only executable via administrators.

Modern field devices solve this problem by means of a built-in web server. This permits complete device servicing, without installation of additional software being necessary. However, the solution with integrated web server is limited to certain bus systems and to specially equipped field devices.

An object of the invention is to provide a system, or a method, which permits each device type to be parametered, or configured, without an earlier installation of additional software being necessary.

The system of the invention comprises:
a computing unit, which accesses field devices via a communications network,
a communications hardware,
at least one server,
at least one interpreter for electronic device descriptions and
a software component,
wherein the server, the interpreter for the electronic device descriptions and the software component are associated with the communications hardware,
wherein the software component, upon the occurrence of an event, identifies, by means of scanning, or polling, the field devices arranged in the communications network and utilizes the identification of the field devices, in order to activate corresponding electronic device descriptions in the interpreter and to provide correspondingly prepared information via the server to the computing unit for the purpose of servicing the field devices.

Used as communications hardware is preferably a modem, while the computing unit is, for example, a stationary PC or a laptop.

The server is preferably a web server, which, by means of the interpreter, provides on web pages the parametering/configuration data associated with a field device, or a field device type. Alternatively, the server is OPC server, an OPC-UA server or an FDI server.

An advantageous embodiment of the system of the invention provides that the field devices are connected with one another via a fieldbus of automation technology.

In an advantageous embodiment, the server, e.g. the web server, is integrated into the communications hardware. Furthermore, it is provided that the server, e.g. the web server is connected, or connectable, to the communications hardware, for example, via a USB connection.

Moreover, it is provided that the communications hardware has supplementally a WLAN connection and/or a LAN connection, in order to be able to access the web pages. Considered as especially advantageously is when, furthermore, the energy supply of the communications hardware, e.g. the modem, occurs via the USB connection.

The solution of the invention includes, furthermore, a method for servicing field devices in an automation plant, wherein the method is performable especially with a system as earlier described. The method of the invention comprises method steps as follows:
connecting the communications hardware, e.g. the modem, with the communications network;
scanning, or polling, for the purpose of identifying field devices connected to the communications network;
starting the server, e.g. the web server, and the interpreter;
loading electronic device descriptions for the identified field devices by the server, e.g. the web server;
producing pages, e.g. web pages, for the identified field devices;
accessing the pages, e.g. web pages, for the identified field devices via the computing unit; and
servicing the identified field devices via the computing unit.

In an advantageous embodiment of the method of the invention, it is provided that the electronic device descriptions are automatically updated, as soon as the communications hardware, e.g. the modem, has established a connection to an external server.

The invention will now be explained in greater detail based on the drawing, the sole FIGURE of which shows as follows:

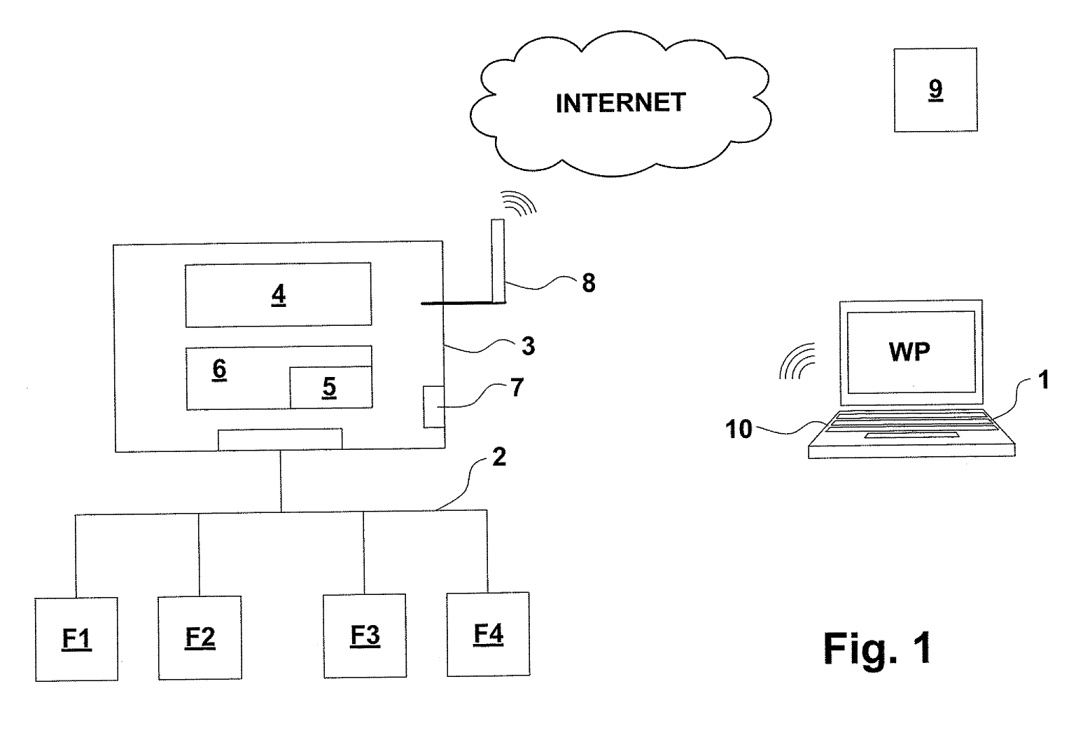

FIG. 1 a schematic representation of the system of the invention.

FIG. 1 shows a schematic representation of the system of the invention, including an intelligent communications hardware 3, e.g. an intelligent modem 3. Preferably, modem 3 is a HART modem.

The system of the invention for servicing field devices F1, F2, F3, F4 in an automation plant further includes a computing unit 1 (PC, laptop, etc.), which via a communications network accesses the field devices F1, F2, F3, F4, and, in the communications hardware 3, a server 4, an interpreter 5 for electronic device descriptions EDD and a software component 6. The meanings of the terminology, ‘field device’ and ‘communications network’, has already been described above. Of course, the communications network 2 can be composed of a plurality of portions, on which communication occurs via different protocols. A conversion of the protocols occurs, in given cases, with application of a gateway.

The server 4, the interpreter 5 for the electronic device descriptions EDD and the software component 6 are integrated into the communications hardware 3. In the case of occurrence of an event, the software component 6 scans, or polls, the field devices F1, F2, F3, F4 arranged in the communications network 2 for the purpose of identifying the field devices F1, F2, F3, F4. The occurrence of an event can be, for example, the start-up of the automation plant or of a field device. The event can also be that, at certain, predetermined intervals in time, a network scan, or polling, is initiated. The resulting identification of the field devices F1, F2, F3, F4 is utilized by the software component 6 to activate corresponding electronic device descriptions EDD in the interpreter 5 and to provide correspondingly prepared information via the server 4 to the computing unit 1 for the purpose of servicing the field devices F1, F2, F3, F4. If the server 4 is a web server, then, by means of the interpreter 5, the parametering/configuration data associated with the field devices F1, F2, F3, F4, or the field device types, are provided on web pages WP to the computing unit 1.

Furthermore, modem 3 has via an interface (e.g. USB, LAN, WLAN), which publishes web pages WP with conventional means, so that any authorized user (client) can access the web pages WP.

The method of the invention preferably works in the following way. As soon as the communications hardware 3, e.g. the modem, is connected with the communications network 2, a scan, or polling, is started, in order to identify the field devices F1, F2, F3, F4 connected to the communications network 2. The server 4, e.g. the web server, and the interpreter are started. Then, the electronic device descriptions EDD for the identified field devices F1, F2, F3, F4 are loaded by the server 4, e.g. the web server. By means of the interpreter 5, web pages WP for the identified field devices F1, F2, F3, F4 are produced. Computing unit 1 is then used to access the web pages WP for the identified field devices F1, F2, F3, F4. From then on, the identified field devices F1, F2, F3, F4 can be serviced via the computing unit 1. The meaning of the term ‘servicing’ is explained above.

Especially advantageous is when the electronic device descriptions EDD are automatically updated, as soon as the communications hardware 3, e.g. the modem, is connected with the communications network 2, following which the modem establishes, e.g. via a wireless radio connection, a connection to the external server 9, on which are stored, among other things, the current electronic device descriptions EDD for the field devices F1, F2, F3, F4.

1-11. (canceled)

12. A system for servicing field devices in an automation plant, comprising:
a communications network;
a computing unit, which accesses the field devices via said communications network;
a communications hardware;
a server;
an interpreter for electronic device descriptions; and
a software component, wherein:
said server, said interpreter for the electronic device descriptions and said software component are associated with said communications hardware;
said software component, upon the occurrence of an event, identifies, by means of scanning, or polling, the field devices arranged in said communications network and utilizes the identification of the field devices, in order to activate corresponding electronic device descriptions in said interpreter and to provide correspondingly prepared information via said server to said computing unit for the purpose of servicing the field devices.

13. The system as claimed in claim 12, wherein:
said server is a web server, which, by means of said interpreter, provides on web pages the parametering/configuration data associated with a field device, or a field device type.

14. The system as claimed in claim 12, wherein:
said server is one of: an OPC server, an OPC-UA server or a FDI server.

15. The system as claimed in claim 12, wherein:
the field devices are connected with one another via a fieldbus of automation technology.

16. The system as claimed in claim 12, wherein:
said communications hardware is a modem.

17. The system as claimed in claim 12, wherein:
said computing unit is one of: a stationary PC or a laptop.

18. The system as claimed in claim 12, wherein:
said server, or, as the case may be, the web server, is integrated into said communications hardware or is connected, or connectable, to said communications hardware, for example, via a USB connection.

19. The system as claimed in claim 18, wherein:
said communications hardware has supplementally one of: a WLAN connection, a USB connection and/or a LAN connection, in order to be able to access the web pages.

20. The system as claimed in claim 19, wherein:
the energy supply of said communications hardware, or, as the case may be, the modem, occurs via said USB connection or said LAN-connection.

21. The method for servicing field devices in an automation plant, the method is performable with a system comprising: a communications network; a computing unit, which accesses the field devices via said communications network; a communications hardware; a server; an interpreter for electronic device descriptions; and a software component, wherein: said server, said interpreter for the electronic device descriptions and said software component are associated with said communications hardware; said software component, upon the occurrence of an event, identifies, by means of scanning, or polling, the field devices arranged in said communications network and utilizes the identification of the field devices, in order to activate corresponding electronic device descriptions in said interpreter and to provide correspondingly prepared information via said server to said computing unit for the purpose of servicing the field devices;
the method comprises the steps of:
connecting the communications hardware, or, as the case may be, the modem, with the communications network;
scanning, or polling, for the purpose of identifying field devices connected to the communications network;
starting the server, or, as the case may be, the web server, and the interpreter;
loading electronic device descriptions for the identified field devices by the server, or, as the case may be, the web server;
producing pages, e.g. web pages, for the identified field devices;
accessing the pages, e.g. web pages for the identified field devices via the computing unit; and
servicing the identified field devices via the computing unit.

22. The method as claimed in claim 21, wherein:
the electronic device descriptions are automatically updated, as soon as the communications hardware, or, as the case may be, the modem, has established a connection to an external server.
